(19) United States
(12) Patent Application Publication
(10) Pub. No.: US 2009/0030999 A1
(43) Pub. Date: Jan. 29, 2009

(54) Contact Proximity Notification

(76) Inventors: Alan D. Gatzke, Bainbridge Island, WA (US); Cary A. Bran, Seattle, WA (US); Jim M. Kerr, Seattle, WA (US)

Correspondence Address: CISCO SYSTEMS, INC.;SCIENTIFIC-ATLANTA, INC., SA/CISCO IP DEPT., 5030 SUGARLOAF PARKWAY, LAWRENCEVILLE, GA, 30044, US

(21) Appl. No.: 11/829,126

(22) Filed: Jul. 27, 2007

(51) Int. Cl. G06F 15/16

(52) U.S. Cl. 709/207

(57) ABSTRACT

In one embodiment, a contact proximity notification application identifies a contact in a contact list of a user, determines a current proximity between the contact and the user and automatically generates a notification of the current proximity between the contact and the user for automatic communication to the user.

### TECHNICAL FIELD

The present disclosure generally relates to contact proximity notification.

### BACKGROUND

A mobile user may be near one or more of his contacts without realizing it. The user may want to know if one or more of his contacts are nearby.

### BRIEF DESCRIPTION OF THE DRAWINGS

FIG. 1 illustrates an example system for contact proximity notification; and

FIG. 2 illustrates an example method for contact proximity notification.

### DESCRIPTION OF EXAMPLE EMBODIMENTS

Overview

In one embodiment, a contact proximity notification application identifies a contact in a contact list of a user, determines a current proximity between the contact and the user and automatically generates a notification of the current proximity between the contact and the user for automatic communication to the user.

Description

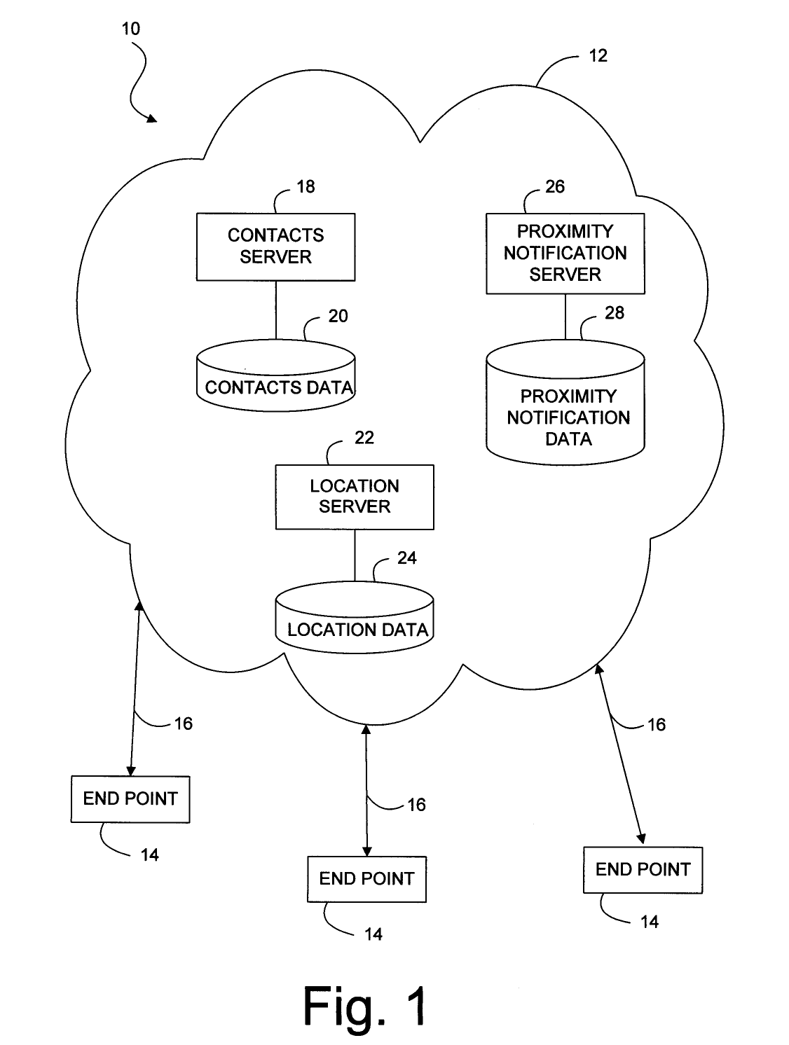

FIG. 1 illustrates an example system 10 for contact proximity notification. System 10 includes endpoints 14 that communicate with each other via network 12. In particular embodiments, network 12 is a local area network (LAN), a wireless LAN (WLAN), a wide area network (WAN), a metropolitan area network (MAN), a portion of the Internet, or another network 12 or a combination of two or more such networks 12. In particular embodiments, network 12 connects to one or more other networks, such as, for example, the Internet, the Public Switched Telephone Network (PSTN), or both. The present invention contemplates any suitable network 12. One or more links 16 couple an endpoint 14 to network 12. In particular embodiments, one or more links 16 each include one or more wired, wireless, or optical links 16. In particular embodiments, one or more links 16 each include a LAN, a WLAN, a WAN, a MAN, a portion of the Internet, an access network, a gateway, or another link 16 or a combination of two or more such links 16. The present invention contemplates any suitable links 16 coupling endpoints 14 to network 12.

Endpoints 14 enable users at endpoints 14 to communicate with each other, with other components of system 10, or both. As an example and not by way of limitation, an endpoint 14 may include a mobile telephone (which may, but need not, have voice over internet protocol (VoIP) capabilities), a personal digital assistant (PDA), a computer system, or another endpoint 14 or a combination of two or more such endpoints 14. A mobile telephone may be a wireless telephone capable of connecting to an 802.11 or other WLAN, a cellular telephone network, or both. A computer system may be a notebook computer system capable of connecting to an LAN, a WLAN, or both. The present invention contemplates any suitable endpoints 14.

Network 12 includes a contacts server 18. In particular embodiments, contacts server 18 includes one or more contacts servers 18. In particular embodiments, contacts server 18 is hardware, software, or embedded logic component or a combination of two or more such components residing at one or more servers in network 12. In particular embodiments, contacts server 18 includes or has access to one or more databases capable of storing contacts data 20. A user may have his contacts profile on contacts server 18. A user may have a contacts list on the contacts server 18. The contacts list identifies the contacts of the user. The contacts list provides information on each contact of the user. Contacts data 20 may include one or more contacts name, address, phone-numbers, email address, fax number and other information like birthday or favorite preferences etc.

The contacts server 18 may receive updated contacts information from different contacts applications. In particular embodiments, the contacts server 18 may periodically query a contacts application for updated contact information of a particular user. The contacts application may respond with updated contact information list for the user. In particular embodiments, the contacts server 18 may request the contacts application to periodically send updated contact information for the user. The contacts application on receiving update request from a contacts server 18 may periodically send the updated contact information to the contacts server 18. In particular embodiments, the contacts applications are Plaxo, LinkedIn, Messenger applications, Email Exchange servers and/or databases.

In particular embodiments, the contacts server 18 may receive updated contacts information from an input device, a user interface, and a software application or web page developed to accept such information. In particular embodiments, the contacts server 18 may receive updated contacts information from an endpoint 14. The contacts server 18 may query an endpoint 14 to receive contact data. The endpoint 14 may respond by sending an updated contact list. In particular embodiments, the contacts server 18 may request the endpoint 14 to periodically send updated contact data information. The endpoint 14 may accept or reject such a request. If the endpoint 14 accepts such a request, the endpoint 14 from that point onwards would periodically transmit updated contact data information to the contacts server 18.

Network 12 also includes a location server 22. In particular embodiments, location server 22 includes one or more location servers 22. In particular embodiments, location server 22 is hardware, software or embedded logic component or a combination of two or more such components residing at one or more servers in network 12. In particular embodiments, location server 22 includes or has access to one or more databases capable of storing location data 24. A user may have location data 24 associated with him. The location data 24 of a user identifies the user's location at a given time. Location data 24 may include user name and location information. In particular embodiments, the location server 22 is wireless, wired or combination of wireless and wired location appliance server. In particular embodiments, the location server 22 is a global positioning system.

In particular embodiments, the endpoints 14 periodically send their current location information to be updated to the location server 22. In particular embodiments, the location server 22 may periodically query the endpoints 14 to receive current location information. In particular embodiments, a contact may have an endpoint 14 associated with him. When the contact moves to another location the location server 22 receives updated location data 24 for the contact. The location server 22 aggregates different location data 24 from different contacts on the contacts list given by the contacts server 18. In particular embodiments, the location server 22 may compare and calculate the proximity information for different contacts based on the location data 24 of the contacts with the location data 24 of the user.

Network 12 also includes a proximity notification server 26. In particular embodiments, proximity notification server 26 includes one or more proximity notification servers 26. In particular embodiments, proximity notification server 26 is hardware, software or embedded logic component or a combination of two or more such components residing at one or more servers in network 12. In particular embodiments, proximity notification server 26 includes or has access to one or more databases capable of storing proximity notification data 28. Proximity notification data 28 gives the proximity information of a user to a contact. The proximity notification data 28 is deduced from the location data 24 of the user and the contact. For example, the proximity notification data may tell the user if a given contact is within 25 miles of the user. Proximity notification data 28 may include a combination of contact data and location data including approximate distance between the contact and the user. In particular embodiments, the proximity notification server 26 sends automatic proximity notification to endpoints 14. The proximity notification sent to the endpoints 14 could be presented in several forms. In particular embodiments, the proximity notification is a pop-up message, voice mail message or web-browser based form.

In particular embodiments, the proximity notification server 26 may periodically receive proximity notification data 28 from the location server 22. In particular embodiments, the proximity notification server 26 may periodically receive location data 24 from the location server 22 for a contacts list of a user. The proximity notification server 26 may calculate the proximity data for a user compared to the contact based on the location data 24 for both the user and the contact. In particular embodiments, the proximity notification server 26 may periodically request the location server 22 to give proximity notification data 28 for a contacts list of a user. In particular embodiments, the location server 22 may be configured to send an updated location data 24 whenever there is change in the location data 24 for a contacts list of a user to a proximity notification server 26.

A user is available to receive proximity notifications through endpoints 14. The proximity notification server 26 identifies a contact on the contact list of a user by communicating with the contacts server 18. The proximity notification server 26 then communicates with the location server 22 to receive the current location data of the identified contact. On receiving the current location data, the proximity notification server 26 sends an automatically generated notification of the current proximity between the contact and the user for automatic communication to the user.

In particular embodiments, the proximity notification is only sent to the user based on rules specified by the user. In particular embodiments, the user may specify a contact list to act on and generate automatic proximity notification. In particular embodiments, the user may specify the maximum proximity between the contact and the user to receive notification. In particular embodiments, the user may have the option of turning off the feature of receiving automatic proximity notifications. In particular embodiments, the user may choose particular day or time to receive automatic proximity notification and disable receiving automatic proximity notification at other times. In particular embodiments, the automatic proximity notification may be sent based on whether the contact and the user are on a same floor of a same building or whether the contact and the user are in the same airport of a same city.

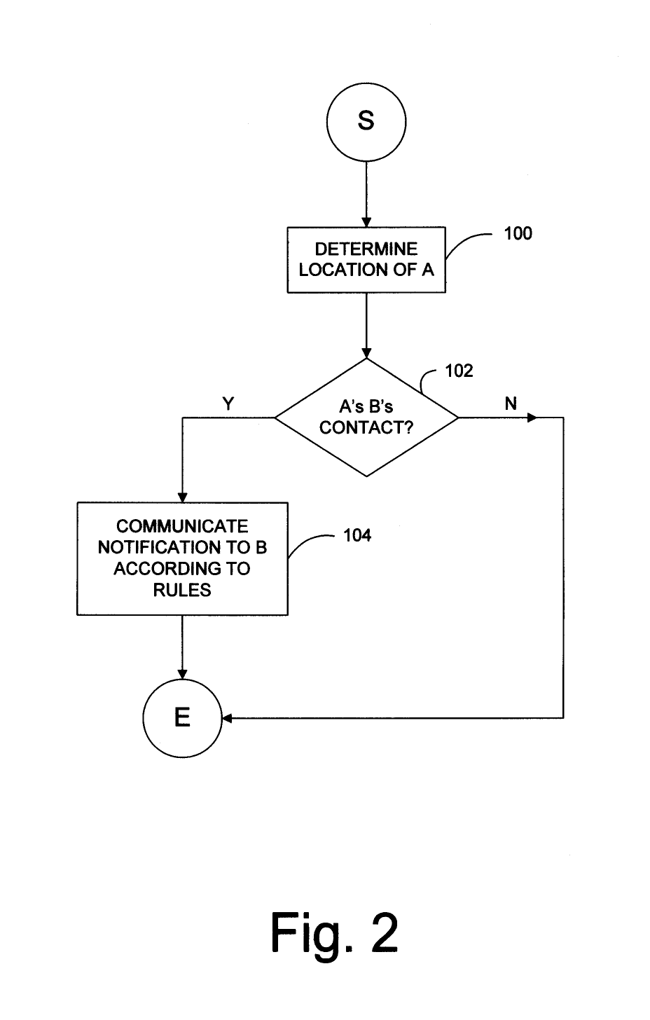

FIG. 2 illustrates an example method for automatic proximity notification of a contact to a user. The method begins at step 100, where a first user A is available and the location information of the user A is determined. At step 102, it is determined whether another user B is a contact of first user A. At step 104, if user B is contact of user A then automatic proximity notification is generated and sent to user B according to the rules defined by the user B. If user A is not a contact of user B then automatic proximity notification is not generated and not sent to user B. In particular embodiments, user B may specify the rules to receive proximity notification. For example, user B may choose a subset of his contacts to receive proximity notification. In another example, user B may specify the rule that proximity notification is to be received only when a contact is in the same building, same city or within X miles of user B. Although particular steps in the method illustrated in FIG. 2 have been illustrated and described as occurring in a particular order, the present invention contemplates any suitable steps of the method illustrated in FIG. 2 occurring in any suitable order. Although the method illustrated in FIG. 2 involves two users, the present invention contemplates any suitable number of users.

The present disclosure encompasses all changes, substitutions, variations, alterations, and modifications to the example embodiments described herein that a person having ordinary skill in the art would comprehend. Similarly, where appropriate, the appended claims encompass all changes, substitutions, variations, alterations, and modifications to the example embodiments described herein that a person having ordinary skill in the art would comprehend.

What is claimed is:

1. An apparatus comprising:
one or more processors; and
a memory coupled to the processors comprising instructions executable by the processors, the processors operable when executing the instructions to:
identify a contact in a contact list of a user;
determine a current proximity between the contact and the user; and
automatically generate a notification of the current proximity between the contact and the user for automatic communication to the user.

2. The apparatus of claim 1, wherein the notification indicates an approximate distance between the contact and the user.

3. The apparatus of claim 1, wherein the processors are operable when executing the instructions to automatically generate the notification according to a set of rules specified by the user.

4. The apparatus of claim 3, wherein the rules specify the contact list.

5. The apparatus of claim 3, wherein the rules specify a maximum proximity between a contact in the contact list and the user for notification.

6. The apparatus of claim 3, wherein the rules specify whether to automatically generate the notification for communication to the user.

7. The apparatus of claim 1, wherein the processors are further operable when executing the instructions to download the contact list from a database, an exchange server, or a contacts application.

8. The apparatus of claim 1, wherein the processors are operable when executing the instructions to determine the current proximity according to information from a location appliance server.

9. The apparatus of claim 1, wherein the processors are operable when executing the instructions to determine the current proximity according to information from a global positioning system.

10. The apparatus of claim 1, wherein the processors are further operable when executing the instructions to withhold the notification if the contact has disabled notification of the current proximity between the user and the contact.

11. The apparatus of claim 1, wherein the current proximity between the contact and the user comprises the contact and the user being currently located on a same floor of a same building.

12. A method comprising:
identifying a contact in a contact list of a user;
determining a current proximity between the contact and the user; and
automatically generating a notification of the current proximity between the contact and the user for automatic communication to the user.

13. The method of claim 12, wherein the notification indicates an approximate distance between the contact and the user.

14. The method of claim 12, wherein automatically generating the notification comprises automatically generating the notification according to a set of rules specified by the user.

15. The method of claim 14, wherein the rules specify the contact list.

16. The method of claim 14, wherein the rules specify a maximum proximity between a contact in the contact list and the user for notification.

17. The method of claim 14, wherein the rules specify whether to automatically generate the notification for communication to the user.

18. The method of claim 12, further comprising downloading the contact list from a database, an exchange server, or a contacts application.

19. The method of claim 12, wherein determining the current proximity according to information from a location appliance server.

20. The method of claim 12, wherein determining the current proximity comprises determining the current proximity according to information from a global positioning system.

21. The method of claim 12, further comprising withholding the notification if the contact has disabled notification of the current proximity between the user and the contact.

22. The method of claim 12, wherein the current proximity between the contact and the user comprises the contact and the user being currently located on a same floor of a same building.

23. A system comprising:
a first endpoint coupled to a network; and
a proximity notification server coupled to the network, the server operable to:
identify a contact in a contact list of a user associated with the first endpoint;
determine a current proximity between the contact and the user;
automatically generate a notification of the current proximity between the contact;
automatically communicate the notification to the user; and
the first endpoint operable to present the notification to the user.

24. The system of claim 23, wherein:
a contacts server is coupled to the network and a location server is coupled to the network; and
the proximity notification server is operable to:
receive the contact list from the contacts server to identify the contact; and
receive an indication of current proximity from the location server to determine the current proximity.
